(19) United States
(12) Patent Application Publication
(10) Pub. No.: US 2012/0135280 A1
(43) Pub. Date: May 31, 2012

(54) Multi-Functional Insulation Materials For Thermal Batteries

(75) Inventors: Jahangir S. Rastegar, Stony Brook, NY (US); Shanthi Subramanian, Skillman, NJ (US)

(73) Assignees: VESTA SCIENCES INC., Santee, CA (US); OMNITEK PARTNERS LLC, Ronkonkoma, NY (US)

(21) Appl. No.: 12/955,875

(22) Filed: Nov. 29, 2010

(51) Int. Cl. H01M 6/36

(52) U.S. Cl. 429/52; 429/112

(57) ABSTRACT

A thermal battery including: a casing; a thermal battery cell disposed in the casing and operatively connected to electrical connections exposed from the casing; a fuel and oxidizer mixture disposed at least partially between the casing and the battery cell; and one or more initiators for initiating one or more of the thermal battery cell and the fuel and oxidizer mixture; wherein the fuel and oxidizer mixture produces an exothermic reaction upon initiation and forms a reaction product being a thermal insulator.

### BACKGROUND

1. Field of the Invention

The present disclosure relates generally to components of thermal batteries, and more particularly to multi-functional insulating and heat generating materials for thermal batteries and the like.

2. Prior Art

Thermal batteries represent a class of reserve batteries that operate at high temperatures. Unlike liquid reserve batteries, in thermal batteries the electrolyte is already in the cells and therefore does not require a distribution mechanism such as spinning. The electrolyte is dry, solid and non-conductive, thereby leaving the battery in a non-operational and inert condition. These batteries incorporate pyrotechnic heat sources to melt the electrolyte just prior to use in order to make them electrically conductive and thereby making the battery active. The most common internal pyrotechnic is a blend of Fe and KClO₄. Thermal batteries utilize a molten salt to serve as the electrolyte upon activation. The electrolytes are usually mixtures of alkali-halide salts and are used with the Li(Si)/FeS₂ or Li(Si)/CoS₂ couples. Some batteries also employ anodes of Li(Al) in place of the Li(Si) anodes. Reserve batteries are inactive and inert when manufactured and become active and begin to produce power only when they are activated.

Thermal batteries have long been used in munitions and other similar applications to provide a relatively large amount of power during a relatively short period of time, mainly during the munitions flight. Thermal batteries have high power density and can provide a large amount of power as long as the electrolyte of the thermal battery stays liquid, thereby conductive. The process of manufacturing thermal batteries is highly labor intensive and requires relatively expensive facilities. Fabrication usually involves costly batch processes, including pressing electrodes and electrolytes into rigid wafers, and assembling batteries by hand. The batteries are encased in a hermetically-sealed metal container that is usually cylindrical in shape. Thermal batteries, however, have the advantage of very long shelf life of up to 20 years that is required for munitions applications.

Thermal batteries generally use some type of igniter to provide a controlled pyrotechnic reaction to produce output flame or hot particles to ignite the heating elements of the thermal battery. There are currently two distinct classes of igniters that are available for use in thermal batteries. The first class of igniters operate based on electrical energy. Such electrical igniters, however, require electrical energy, thereby requiring an onboard battery or other power sources with related shelf life and/or complexity and volume requirements to operate and initiate the thermal battery. The second class of igniters, commonly called “inertial igniters,” operate based on the firing acceleration. The inertial igniters do not require onboard batteries for their operation and are thereby often used in high-G munitions applications such as in non-spinning gun-fired munitions and mortars.

In general, the inertial igniters, particularly those that are designed to operate at relatively low impact levels, have to be provided with the means for distinguishing events such as accidental drops or explosions in their vicinity from the firing acceleration levels above which they are designed to be activated.

Insulation and internal heat sinks are used to maintain the electrolyte in its molten and conductive condition during the time of use following their activation. The length of time that the electrolyte stays molten determines the active life of the battery. To increase the active life, the amount of available heat energy needs to be increased and/or more effective insulation material needs to be provided. For smaller size thermal batteries, the volume of the insulation material that can be provided becomes limited. In addition, since the ratio of the surface area to the enclosed molten material volume increases as the battery volume is decreased, the effectiveness of the insulation material decreases as the size of the thermal battery decreases.

The following is a brief description of the thermal battery disclosed in U.S. Pat. No. 3,898,101 “Thermal Battery” by D. M. Bush, et al. However, it must be noted that this selection is for purposes of illustration only and is used for describing similar components with respect to the various embodiments disclosed herein.

As it is shown in the schematic of FIG. 1, reproduced from U.S. Pat. No. 3,898,101, the thermal battery may include a plurality of electrochemical cells 10 stacked one upon the other in electrical series within a suitable casing 12 and thermal insulating barrier 14. Electrical connections may be made in an appropriate manner by suitable electrical leads and terminals 16, 17, and 18 to the respective positive and negative terminals of the upper and lower battery cells in the stack. The heat or thermal generating elements for the battery, which are generally positioned as a part of each battery cell with or without additional heat generating elements at each end of the battery, may be ignited to activate the battery by a suitable electrical match or detonator 20 and heat powder or fuse 22 which is coupled between the match 20 and the heating generating elements in each cell. The battery is normally formed by first stacking the individual cell elements to form separate cells and then the cells stacked together in the form shown in FIG. 1 and placed within the casing 12 and insulator 14 under suitable pressure, such as by a compression force applied by a bolt 23 passing through the center of the cells, or other suitable mechanisms. The so stacked battery cells may then be covered with an end insulator 24 and a casing cover 25 in an appropriate manner. The battery is operated by initiating the electrical match 20 and in turn the heat powder 22 and the individual heat generating elements of the cell stack and the electrical current drawn off through leads 16, 17, and 18.

A need therefore exists for methods and materials that can be used to keep thermal batteries in general and small thermal batteries in particular operational longer following activation. For those applications in which the operational life of the thermal battery following activation is not an issue, such methods and material can be used to reduce the insulation volume requirement, thereby allowing the size of the thermal battery to be reduced. The material used for thermal insulation must also be electrically non-conducting.

### SUMMARY

Provided herein are methods to develop multi-functional heat insulation for thermal batteries and the like that can be used to provide heat to the battery to increase its operational time and performance as well as serving as heat insulation material.

Further provided are methods to develop multi-functional heat insulation for thermal batteries and the like that can be used to provide heat insulation as well as provide heat to the battery on demand to prolong the battery operational time and performance.

Still further provided are multi-functional insulation materials that can be used in thermal batteries to serve as thermal insulation as well as source of generating heat to the battery to prolong the battery operational time and performance.

Still further yet provided are multi-functional insulation materials that can be used in thermal batteries to serve as thermal insulation as well as source of heat to the battery on demand to prolong the battery operational time and performance.

Accordingly, a thermal battery is provided. The thermal battery comprising: a casing; a thermal battery cell disposed in the casing and operatively connected to electrical connections exposed from the casing; a fuel and oxidizer mixture disposed at least partially between the casing and the battery cell; and one or more initiators for initiating one or more of the thermal battery cell and the fuel and oxidizer mixture; wherein the fuel and oxidizer mixture produces an exothermic reaction upon initiation and forms a reaction product being a thermal insulator.

The casing can include a casing cover.

The thermal battery cell can be selected from a list consisting of perchlorates, nitrates, permanganates, fluorinated polymers and metal oxides

The fuel and oxidizer mixture can comprise silicon nanosponge particles and porous silicon particles. The silicon nanosponge particles can be prepared from metallurgical grade silicon powder having an initial particle size ranging from about 1 micron to about 4 microns, the silicon nanosponge particles can have a plurality of nanocrystals having pores. The porous silicon particles can be prepared from a metallurgical grade silicon powder having a solid core surrounded by a porous silicon layer having a thickness greater than about 0.5 microns. The reaction product of the fuel and oxidizer mixture can be silica.

The thermal battery can further comprise an insulator disposed between the fuel and oxidizer mixture and the casing.

The thermal battery can further comprise an additional insulator disposed between the fuel and oxidizer mixture and the battery cell.

The thermal battery can further comprise an insulator disposed between the fuel and oxidizer mixture and the battery cell.

The fuel and oxidizer mixture can comprise at least first and second fuel and oxidizer mixtures separated by an insulator.

Also provided is a method of initiating a thermal battery. The method comprising; disposing a thermal battery cell in a casing; disposing a fuel and oxidizer mixture at least partially between the casing and the battery cell; initiating the fuel and oxidizer mixture; wherein the initiating includes producing an exothermic reaction and forming a reaction product being a thermal insulator.

The method can further comprise insulating the exothermic reaction on a side of the fuel and oxidizer mixture between the fuel and oxidizer mixture and the casing.

The method can further comprise insulating the exothermic reaction on a side of the fuel and oxidizer mixture between fuel and oxidizer mixture and the battery cell.

The disposing of the fuel and oxidizer mixture can comprise disposing first and second fuel and oxidizer mixtures between an insulator.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic of a cross-section of a thermal battery and igniter assembly of the prior art.

FIG. 2 illustrates a schematic of a first embodiment of a thermal battery.

FIG. 3 illustrates a close-up view of the casing and insulation section of the thermal battery shown in FIG. 2.

FIG. 4 illustrates a close-up view of the casing and insulation sections of a second embodiment of a thermal battery.

FIG. 5 illustrates a close-up view of the casing and insulation sections of a third embodiment of a thermal battery.

FIG. 5 illustrates a close-up view of the casing and insulation sections of a fourth embodiment of a thermal battery.

### DETAILED DESCRIPTION

An embodiment of a thermal battery includes a mixture of fuel(s) and oxidizer(s) which exhibits an exothermic reaction upon initiation, generating heat to prolong the battery operation and where the reaction product (including any residual fuel) is one that can provide thermal insulation. Preferred fuels for the aforementioned multi-functional insulation material are silicon nanosponge particles and porous silicon particles as described in U.S. Pat. Nos. 7,560,085 and 756,920, the contents of which are incorporated herein by reference. Silicon nanosponge particles are prepared from a metallurgical grade silicon powder having an initial particle size ranging from about 1 micron to about 4 microns. Each silicon nanosponge particle has a structure comprising a plurality of nanocrystals with pores disposed between the nanocrystals and throughout the entire nanosponge particle. Porous silicon particles having a particle size >0.5 micron are also prepared from a metallurgical grade silicon powder but comprise a solid core surrounded by a porous silicon layer having a thickness greater than about 0.5 microns. The silicon nanosponge and porous silicon particles together with appropriate oxidizers can be formulated to burn at a desired rate and to form the chemical compound silicon dioxide, SiO₂, also known as silica. Silica has very high thermal insulation and electrical insulation characteristics. By using the proper type and amount of oxidizers, the amount of gasses can be generated during the process of burning of the silicon nanosponge material is minimized. The Table shows the expected reaction of silicon with various oxidizers and the estimated heat of reaction. Oxidizers including but not limited to perchlorates, nitrates, permanganates, fluorinated polymers and metal oxides can be used. The oxidizer may be chosen based on the desired burn rate and ignition characteristics. The Brunauer.Emmet.Teller (B.E.T.) surface area of the silicon nanosponge and porous silicon particles can also be changed as described in U.S. Pat. No. 7,560,085, the contents of which are also incorporated herein by reference. The burn rate and heat output can also be controlled by varying the particle size, surface area and porosity of the porous silicon particles. Hereinafter, the silicon nanosponge materials and the porous silicon particles together (“treated”) with the appropriate oxidizers are referred to as the “porous silicon-based pyrotechnic” material.

It will be appreciated by those of ordinary skill in the art that the relative amount of oxidizer used may be selected to oxidize (burn) a desired portion of the silicon nanosponge or porous silicon particle to generate the desired amount of heat per unit volume of the aforementioned “porous silicon-based pyrotechnic” material used in the thermal battery and/or to control (minimize) the amount of gasses that the oxidization process could generate.

TABLE
Summary of reactions of Silicon with various oxidizers and the
theoretical heat of reaction per unit mass and unit volume

| | □Hr (kJ/g) | □Hr (kJ/cc) |
|---|---|---|
| Reaction | (Si + oxidizer) | (Si + oxidizer) |
| Si + O₂ → SiO₂ | −15.2 | −4.5 |
| 2Si + NaClO₄ → 2SiO₂ + NaCl | −10.4 | −16 |
| 2Si + KClO₄ → 2SiO₂ + KCl | −9.4 | −18 |
| 5Si + 4KNO₃ → 5SiO₂ + 2N₂ + 2K₂O | −6.1 | −10 |
| Si + (C₂F₄)ₙ → SiF₄ + 2C | −6.2 | −12 |
| Si + 2CuO → SiO₂ + 2Cu | −3.0 | −12 |
| 3Si + 2Bi₂O₃ → 4Bi + 3SiO₂ | −1.4 | −8.5 |

It is noted that the silicon nanosponge materials and porous silicon particles as well as silica have very high thermal insulation (very low thermal conductivity) characteristics and are therefore good candidates for use as thermal barriers in thermal batteries. In addition, when necessary, particularly for the ease of manufacturing, the silicon particles may be used with appropriate binders to allow them to be formed or molded into the desired shape for use in thermal batteries. However, the molding method should preserve the porosity and surface area of the materials in order to maintain the oxidation characteristics. In general, binders that generate minimal amount of gas when heated to the thermal battery activation temperatures are highly desirable since such gasses can degrade the performance of the thermal battery.

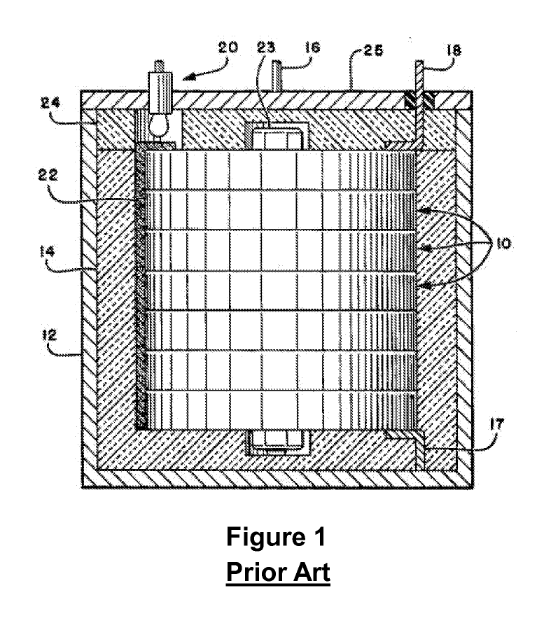

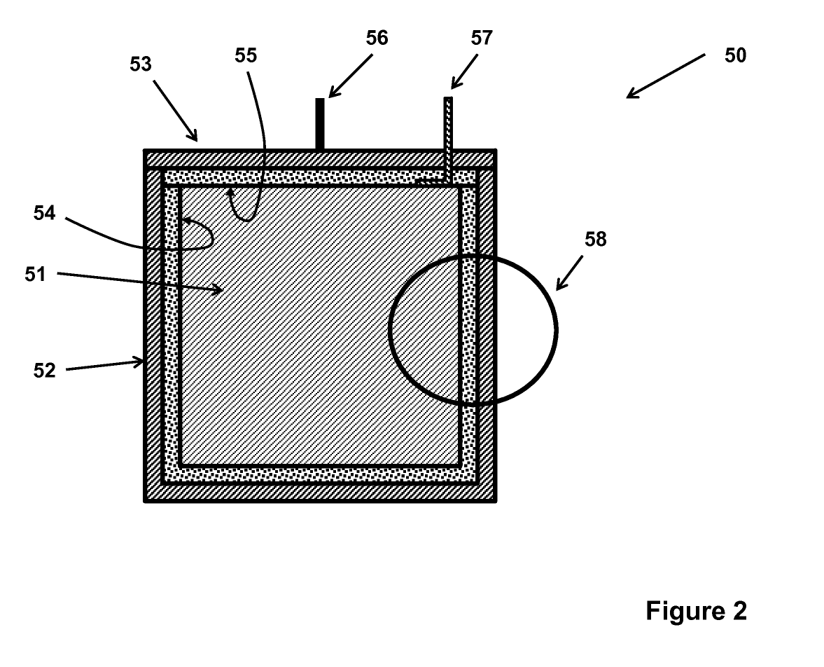

As discussed above, currently available thermal batteries have various electrochemical cell and other internal component and initiation designs. Almost all thermal batteries, however, generally use the insulation materials to enclose the hot interior of the thermal batteries (items 14 and 24 in FIG. 1) and provide a thermal insulating barrier to keep the battery operational for the required length of time. Hereinafter and for the sake of describing the various embodiments disclosed below, the hot interior elements of thermal batteries and the initiation device 20 (excluding the insulating thermal barriers 14 and 24 and the outside shell 12 and the cap 25—FIG. 1) are represented as a single interior element 51 as shown in the schematic of the first embodiment 50 illustrated in FIG. 2.

In the schematic of the first embodiment 50 illustrated in FIG. 2, the aforementioned interior element 51 is enclosed within an appropriate casing 52 and cover 53, usually stainless steel and hermetically sealed. The space between the interior element 51 and the casing 52 and cover 53 is filled with the aforementioned “porous silicon-based pyrotechnic” material 54 and 55, respectively. The thermal battery leads are indicated by numerals 56 and 57.

It will be appreciated by those skilled in the art that any portion of the volume 54 and 55 that is filled with the aforementioned “porous silicon-based pyrotechnic” may instead be filled with any other commonly used (usually organic) insulation material. This might be particularly elected to be done for the cover region 55 where the battery leads 56 and 57 are located.

In operation, once the thermal battery is activated by igniting the heat generating elements of the thermal battery inside the element 51, FIG. 2, the “porous silicon-based pyrotechnic” material 54 and 55 are also ignited as the consequence of the thermal battery activation via the heat generating elements of the battery or via separately provided pyrotechnic elements (not shown). Once the “porous silicon-based pyrotechnic” material 54 and 55 are ignited, as a result of at least partial silicon sponge material burning (oxidation), at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material 54 and 55 has the substantial effect of turning it into an effective thermal barrier while initially providing heat to the thermal battery core 51.

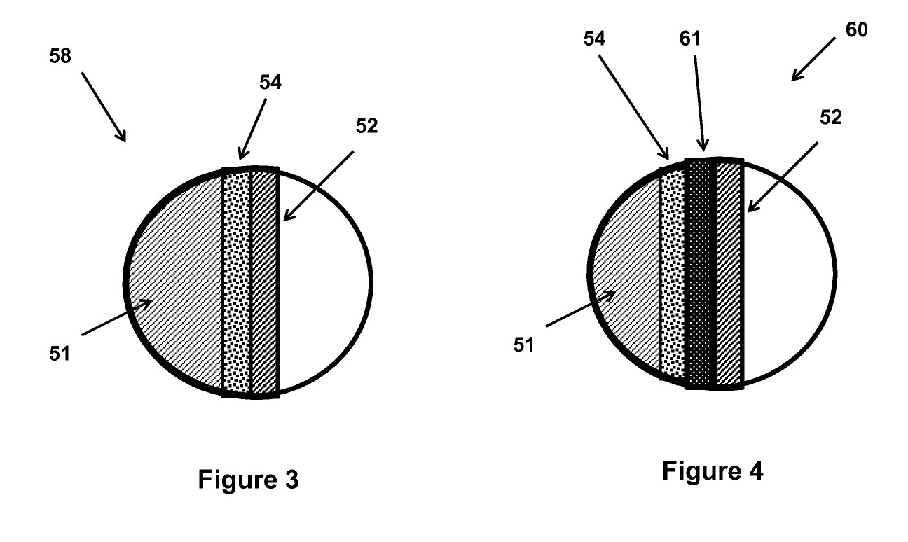

A close-up view 58 of the casing and insulation section 52 and 54, respectively, is shown in FIG. 3. A similar close-up view may also be considered for the cover 53 and its underlying the insulation section 55 and the following embodiments may also be employed in their construction. In the following embodiments, novel methods to construct different configurations of the insulation layer using the aforementioned silicon sponge and “porous silicon-based pyrotechnic” material 54, FIGS. 2 and 3, are disclosed. The advantages and possible shortcomings of each embodiment when used in different types and sizes of thermal batteries and/or their applications are also discussed.

A second embodiment is shown schematically in the close-up view 60 (as replacing the wall section close-up view 58 of the embodiment 50 shown in FIGS. 2 and 3) of FIG. 4. In the embodiment of FIG. 4, an insulation layer 61 (e.g., using any one of the currently available materials known in the prior art) is used between the casing 52 and the aforementioned “porous silicon-based pyrotechnic” material 54.

In operation, once the thermal battery is activated by igniting the heat generating elements of the thermal battery inside the element 51, FIGS. 2 and 4, the “porous silicon-based pyrotechnic” material 54 is also ignited as the consequence of the thermal battery activation via the heat generating elements of the battery or via separately provided pyrotechnic elements (not shown). Once the “porous silicon-based pyrotechnic” material 54 is ignited, as a result of at least partial silicon sponge material burning (oxidation), at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material 54 has the substantial effect of turning it into an effective thermal barrier while initially providing heat to the thermal battery core 51. The addition of the insulation layer 61 will ensure that the generated heat is not conducted out of the thermal battery casing 52.

It is noted that similar two-layer design (layers 61 and 54 in FIG. 4) may be used under the cover 53 (FIG. 2) to achieve the aforementioned effect.

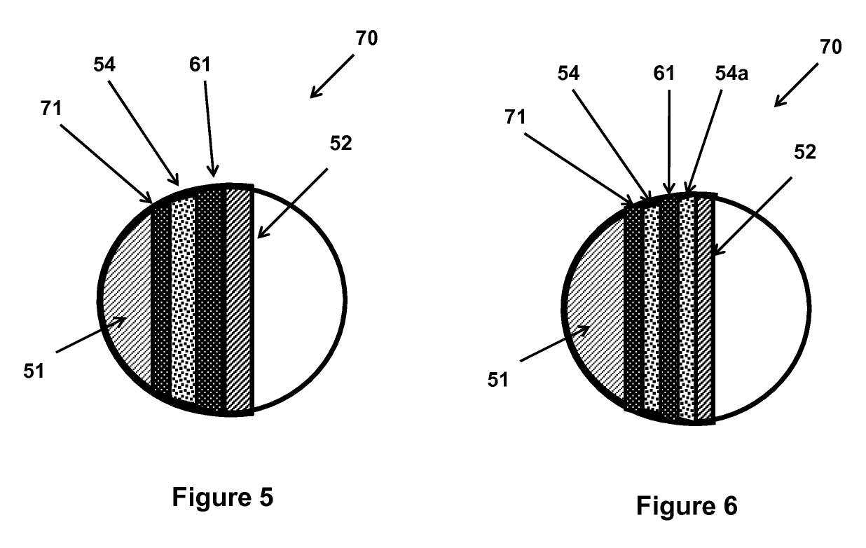

In a third embodiment 70, at least one insulation layer (e.g., using any one of the currently available materials known in the art) and at least one layer of aforementioned “porous silicon-based pyrotechnic” material is used between the aforementioned casing 52 (and possibly the cover 53) and the interior element 50 of the thermal battery (FIGS. 2 and 3). As an example, an additional layer of insulation 71 (using any one of the currently available materials known in the art) may be added to the embodiment of FIG. 4 between the “porous silicon-based pyrotechnic” material 54 and the interior element 51 as shown in the schematic of FIG. 5. The insulation layer 71 may be added to facilitate the packaging of the “porous silicon-based pyrotechnic” material 54, which may be in the form of “loose powder” without the use of added binders that could otherwise generate unwanted gasses.

In operation, once the thermal battery is activated by igniting the heat generating elements of the thermal battery inside the element 51, FIGS. 2 and 4, the “porous silicon-based pyrotechnic” material 54 may also be packaged to be ignited (e.g., by providing an opening in the insulation layer 71—not shown) as a consequence of the thermal battery activation via the heat generating elements of the battery. However, the “porous silicon-based pyrotechnic” material 54 is preferably ignited via separately provided pyrotechnic elements (not shown), possibly a certain period of time before or after the aforementioned thermal battery initiation depending on the design of the thermal battery and its operational requirements and the temperature of the environment to achieve optimal performance of the thermal battery. Once the “porous silicon-based pyrotechnic” material 54 is ignited, as a result of at least partial silicon sponge material burning (oxidation), at least a portion of the silicon sponge material is converted to silica. As a result, firstly, heat is generated, which would have the beneficial effect of keeping the thermal battery operational longer or at least require lesser amounts of heat generating elements, thereby allowing the construction of relatively smaller thermal batteries that would stay operational the same length of time. Secondly, the conversion of the already substantially thermally insulating silicon sponge material to silica would generally increase its thermally insulating characteristics. As a result, the burning of the “porous silicon-based pyrotechnic” material 54 has the substantial effect of turning it into an effective thermal barrier while initially providing heat to the thermal battery core 51. The addition of the insulation layer 61 will ensure that the generated heat is not conducted out of the thermal battery casing 52.

It is noted that similar multi-layer design (layers 61, 54 and 71 in FIG. 5) may be used under the cover 53 (FIG. 2) to achieve the aforementioned effect.

It will be appreciated by those skilled in the art that the embodiment 70 may be constructed with multi-insulation (e.g., using any one of the currently available materials known in the art) and the aforementioned “porous silicon-based pyrotechnic.” For example, one may use more than one sandwiched layers of insulation (e.g., using any one of the currently available materials known in the art) and “porous silicon-based pyrotechnic” materials to provide the means of generating heat by igniting the different “porous silicon-based pyrotechnic” layers sequentially to achieve optimal operational performance of the thermal battery by keeping the battery electrolyte at the desired temperature for a longer period of time.

It is also appreciated by those skilled in the art that neither the insulation material such as layers 61 and 71 in FIG. 5 (e.g., using any one of the currently available materials known in the art) nor the “porous silicon-based pyrotechnic” material layers such as 54 in FIG. 5, have to completely cover the entire side, bottom and/or the top surfaces of the thermal battery core 51. For example, “pockets” or “rings” of “porous silicon-based pyrotechnic” material can be provided within the insulation material layers 61 and/or 71 to localize their generated heat in those areas.

It will also be appreciated by those skilled in the art that any insulation material could be used for layers 61 and/or 71 in FIG. 5. For example, the layer 71 may be formed using the flexible fuel comprising at least one polymeric binding material and porous silicon particles dispersed throughout the polymeric binding material as disclosed in the U.S. Patent application 2009/0101251 of Subramanian, et al. filed on Apr. 23, 2009, the entire contents of which is incorporated herein by reference.

As shown in FIG. 6, two or more of the “porous silicon-based pyrotechnic” material layers 54, 54a can be provided with insulating layers 61, 71 disposed therebetween. In the configuration of FIG. 6, an additional insulting layer can be provided between the thermal battery casing 52 and the “porous silicon-based pyrotechnic” material layer 54a (as shown in FIG. 5).

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A thermal battery comprising:
a casing;
a thermal battery cell disposed in the casing and operatively connected to electrical connections exposed from the casing;
a fuel and oxidizer mixture disposed at least partially between the casing and the battery cell; and
one or more initiators for initiating one or more of the thermal battery cell and the fuel and oxidizer mixture;
wherein the fuel and oxidizer mixture produces an exothermic reaction upon initiation and forms a reaction product being a thermal insulator.

2. The thermal battery of claim 1, wherein the casing includes a casing cover.

3. The thermal battery of claim 1, wherein the thermal battery cell is selected from a list consisting of perchlorates, nitrates, permanganates, fluorinated polymers and metal oxides

4. The thermal battery of claim 1, wherein the fuel and oxidizer mixture comprise silicon nanosponge particles and porous silicon particles.

5. The thermal battery of claim 4, wherein the silicon nanosponge particles are prepared from metallurgical grade silicon powder having an initial particle size ranging from about 1 micron to about 4 microns, the silicon nanosponge particles having a plurality of nanocrystals having pores.

6. The thermal battery of claim 4, wherein the porous silicon particles are prepared from a metallurgical grade silicon powder having a solid core surrounded by a porous silicon layer having a thickness greater than about 0.5 microns.

7. The thermal battery of claim 4, wherein the reaction product of the fuel and oxidizer mixture is silica.

8. The thermal battery of claim 1, further comprising an insulator disposed between the fuel and oxidizer mixture and the casing.

9. The thermal battery of claim 8, further comprising an additional insulator disposed between the fuel and oxidizer mixture and the battery cell.

10. The thermal battery of claim 1, further comprising an insulator disposed between the fuel and oxidizer mixture and the battery cell.

11. The thermal battery of claim 1, wherein the fuel and oxidizer mixture comprises at least first and second fuel and oxidizer mixtures separated by an insulator.

12. A method of initiating a thermal battery, the method comprising;
disposing a thermal battery cell in a casing;
disposing a fuel and oxidizer mixture at least partially between the casing and the battery cell;
initiating the fuel and oxidizer mixture;
wherein the initiating includes producing an exothermic reaction and forming a reaction product being a thermal insulator.

13. The method of claim 12, further comprising insulating the exothermic reaction on a side of the fuel and oxidizer mixture between the fuel and oxidizer mixture and the casing.

14. The method of claim 12, further comprising insulating the exothermic reaction on a side of the fuel and oxidizer mixture between fuel and oxidizer mixture and the battery cell.

15. The method of claim 12, wherein the disposing of the fuel and oxidizer mixture comprises disposing first and second fuel and oxidizer mixtures between an insulator.
